(19) United States
(12) Patent Application Publication
(10) Pub. No.: US 2006/0015439 A1
(43) Pub. Date: Jan. 19, 2006

(54) Shareable quote streams

(76) Inventors: John Edwin Thomas Brann, Hartsdale, NY (US); Neill Penney, Surrey (GB)

Correspondence Address: LAW OFFICES OF GRADY L. WHITE, LLC, 7272 WISCONSIN AVE, SUITE 300, BETHESDA, MD, 20814, US

(21) Appl. No.: 11/155,891

(22) Filed: Jun. 20, 2005

Related U.S. Application Data
(60) Provisional application No. 60/581,764, filed on Jun. 23, 2004.

(51) Int. Cl. G06Q 40/00

(52) U.S. Cl. 705/37

(57) ABSTRACT

Method and apparatus for providing price quote streams to a multiplicity of customers in an online asset trading system. The invention allows providers to establish, maintain and revise only one shareable price quote stream (or, alternatively, just a relative few number of shareable price quote streams) for each currency pair and have that one shareable price quote stream (or that relative few number of shareable price quote streams) automatically converted to customer-specific price quote streams and distributed to a large number of customers simultaneously, without consuming a correspondingly large amount of additional time or resources on the providers' trading system. Each customer-specific price quote stream contains quotes having order size parts that are derived from customer-specific factors, such as the customer's credit limit and/or the customer's requested order size.

### CROSS-REFERENCE TO RELATED APPLICATIONS

This application is related to and claims priority under 35 U.S.C. § 119 to provisional application No. 60/581,764, filed Jun. 23, 2004, which is incorporated into this application in its entirety by this reference.

### FIELD OF ART

The present invention relates generally to automated online asset trading systems and more particularly to automated online asset trading systems where the asset providers send price quotes to customers and potential customers in a substantially continuous stream of data via an intermediate or centralized online trading server.

### RELATED ART

In the asset trading business, including for example the foreign exchange (“FX”) and money markets, customers execute trades through asset dealers (typically, banks or banking institutions), who are referred to as “liquidity providers,” or simply “providers.” In a typical scenario, a customer wishing to buy, sell, lend or borrow some quantity of assets proposes a trading transaction by sending a request for price quotes (referred to as an “RFQ”) to one or more of the providers. The providers respond by returning price quotes for the proposed transaction, which indicate the prices the providers are willing to buy (or borrow) the assets, the prices they are willing to sell (or lend) the assets, as well as the size of the order the provider is willing to deal at the quoted prices. If a customer likes a price quote and wishes to enter into a deal with the sending provider, then the customer transmits to the provider an offer to trade assets for the price stated in the price quote (the offer is typically referred to as an “offer to deal”). If the price quote is still available (i.e., not expired) when the provider receives the customer's offer to deal, and the provider can meet other terms in the RFQ and offer to deal, such as the quantity ordered and the proposed settlement date, then the provider typically accepts the offer to deal, and the proposed transaction is booked and executed. In a slightly different scenario, providers may stream price quotes to customers on a substantially continuous basis without receiving a specific RFQ for each price quote, and customers may initiate a transaction by sending an offer to deal against one or more price quotes within the stream.

Automated asset trading systems have been introduced to facilitate faster, more efficient and, for auditing purposes, more traceable, trading transactions between customers and providers. Typically, these systems comprise a high-level trading application program (or, in some instances, a suite of high-level trading application programs) or a graphical user interface running on a customer's computer system (or network), which receives input from the user and sends electronic trading instructions to one or more high-level trading application programs running on the providers' computer systems (or networks). The customer's computer system and the providers' computer systems talk to each other by exchanging a series of messages via one or more data communication channels established within an interconnected computer network, such as the Internet, a dedicated wide area network (WAN), or a corporate intranet. Typically, the high-level trading application programs and graphical user interfaces create messages and transmit them over the computer network by accessing a predefined collection or library of subroutines and function calls. The collection or library of subroutines and function calls is referred to as an application programming interface (“API”).

With the help of the APIs, the messages carrying quotes and trading instructions over the data communications links in the computer network may be channeled through an intermediate or centralized online trading server (or “portal”), which is also connected to the interconnected computer network. Typically, the intermediate online trading server is configured to coordinate, compare, match, error-check and/or log the messages on behalf of the customers and liquidity providers and communicate responses to the parties in real-time. In some cases, the online trading server is managed and operated by a third party. FX Alliance, LLC of New York, N.Y. (FXall) is one example of a third party operator of an online trading server for the FX market.

In existing stream-enabled online trading systems, the customer will typically transmit to the provider a request to see a stream of quotes (RFQ) for a given currency pair. Usually, although not necessarily, the RFQ is transmitted from the customer's trading system to an intermediate online trading server, which in turn passes the RFQ (essentially unchanged), to the provider's trading system. Typically, the provider reviews the RFQ, and makes a decision whether to service or reject the RFQ. If the provider decides to service the RFQ, then the provider will start sending to the customer a substantially continuous stream of price quotes for the specified currency pair. While the stream of quotes are not exactly secret (because they are typically seen, controlled and/or managed by the intermediate server as they pass through the intermediate server), no other customers of the provider see or have an opportunity to act on the quotes contained in the requested quote stream. In other words, while a quote stream exists, it exists, for all intents and purposes, as a private, dedicated communication channel between the provider's trading system on the one end and the customer trading system on the other. Therefore, if a provider receives from a second customer a second RFQ for the same currency pair, then the provider must establish a second quote stream in order to service the second RFQ. This means the provider must utilize a second dedicated, end-to-end communication channel to service the RFQ for the second customer. Servicing a third RFQ from a third customer for the same currency pair requires establishing a third dedicated communications channel; servicing a fourth RFQ from a fourth customer requires establishing a fourth dedicated communications channel, and so on.

Moreover, each currency pair requires its own price quote stream. A provider cannot, for example, send a customer price quotes for the euro-dollar currency pair (abbreviated as “EUR.USD”) in a stream containing price quotes for the dollar-yen currency pair (abbreviated as “USD.JPY”). Therefore, if a customer who is already receiving a EUR.USD price quote stream also sends a second RFQ to receive a USD.JPY quote stream, then the provider must establish a new and separate quote stream for that customer in the USD.JPY currency pair in order to service the second RFQ. If a customer also wants to review price quotes for a third, fourth and fifth currency pair, then he must have access to a third, fourth and fifth price quote stream, and so on.

Providing a separate quote stream for every currency pair and every customer is not only very inefficient, it also consumes a considerable amount of resources on the provider's trading system. It would not be unusual, for instance, for one provider to support fifty different currency pairs and a thousand different customers. The conventional online trading systems require that the provider establish, maintain, update and revise fifty-thousand different price quote streams.

In addition, every time the provider wishes to revise its price for a particular currency pair for all of its customers, the provider must send a separate (and duplicate) price change on every one of the existing price streams. Although modern computer systems are capable of executing instructions at very high speeds, when the computer system must deal with instructions associated with potentially fifty-thousand or more different price quote streams, sending out separate and duplicate price change instructions for every price quote stream creates a substantial number of resource, timing and latency problems for both providers and customers.

Accordingly, there is a considerable need in the online trading business for automated online trading systems, mechanisms and methods that give providers the ability to establish, maintain and revise only one price quote stream (or, alternatively, just a relative few number of price quote streams) for each currency pair and have that one price quote stream (or that relative few number of price quote streams) automatically distributed to a large number of customers simultaneously, without consuming a correspondingly large amount of additional time or resources on the providers' trading system.

### SUMMARY OF THE INVENTION

Shareable Price Quote Streams

The present invention addresses the above-described need, as well as other needs and issues hereinafter described, by providing systems and methods for generating and distributing a large number of customer-specific price quote streams to a multiplicity of customers, each customer-specific price quote streams being derived from one “shareable” price quote stream, or alternatively, a relative few number of “shareable” price quote streams. So, if a provider supports fifty different currency pairs and a thousand customers, the invention permits the provider to establish, maintain, update, revise and deliver only fifty “shareable” price quote streams (i.e., one price quote stream for each currency pair) instead of fifty-thousand “private” price quote streams.

Price quotes typically comprise at least two parts, a price part and a size part. The size part of the quote specifies the maximum order size the provider is willing to trade at the price specified in the price part of the quote. The size part is typically based on a customer's credit limit with the provider, the provider's ability to supply or sell the assets in question, the provider's assessment of the overall market risk associated with the particular customer or the particular type of asset, or some combination of two more of these factors. Since the order size part may be different for every customer, and theoretically, could be different for every successive quote sent to a customer, a “shareable” quote, according to the present invention, typically comprises the price part and not the order size part. The invention receives these shareable price quotes from the provider trading system in one or more incoming streams and automatically converts each price quote into a customer-specific price quote for each customer by supplying to the price quote the appropriate size part. The invention then delivers each of the customer-specific price quotes to the appropriate customer in an outgoing stream.

In one aspect of the invention there is provided a method of distributing quotes in an online asset trading network, comprising the steps of: (a) establishing with a provider trading system a first shareable quote stream for a currency pair, the first shareable quote stream having a tier limit; (b) receiving from a customer trading system a request for quotes comprising a requested order size; (c) transmitting the request for quotes to the provider trading system; (d) receiving from the provider trading system a quote control gesture comprising an available order size for the customer trading system; (e) receiving a shareable quote from the provider trading system via the first shareable quote stream; (f) converting the shareable quote into a customer-specific quote comprising a size part equal to the minimum of the tier limit, the available order size and the requested order size; (g) sending the customer-specific quote to the customer trading system; and (h) iteratively repeating steps (e)-(g) until an occurrence of a specified event.

The tier limit for a shareable quote stream comprises an upper limit, or ceiling, for the shareable quote stream, beyond which the provider is not willing to deal at the quoted price for any customer. Utilizing this tier limit value, a provider may opt to establish multiple shareable quote streams for the same currency pair, each one having different prices and different price ceiling. The ability to establish multiple shareable price quote streams for each currency pair is extremely useful to a provider, for example, when the provider wishes to show customers slightly different prices depending on the potential size of the customers' orders, as defined by the tier limit. Typically, although not necessarily, providers offer slightly better prices for smaller orders because smaller orders usually do not involve the same level of market risk.

Thus, it may be necessary or desirable, for example, for a provider to establish a first tier of EUR.USD price quotes for customers capable of executing orders with order sizes up to $20 million, a second tier of EUR.USD price quotes for customers capable of executing orders with order sizes up to $50 million, and a third tier of EUR.USD price quotes for customers capable of executing orders with order sizes up to $100 million. The three EUR.USD tiers would then be represented by three different price quote streams, all having different prices for the EUR.USD currency pair. Usually, the shareable quote stream having the largest tier limit value will have prices more favorable to the provider and less favorable to the customer. Then the provider can then link customers to the appropriate EUR.USD price quote stream, depending on the potential order size for each customer and the prices the provider would like to offer those customers.

Accordingly, preferred embodiments of the invention supports setting up and using any number of different tiers of shareable quote streams for the same currency pair. More specifically, preferred embodiments of the method may include the steps of establishing with the provider trading system a second shareable quote stream for the same currency pair, the second shareable quote stream having a different tier limit, receiving from the provider trading system a second quote control gesture comprising an identifier for the second shareable quote stream, and until an occurrence of a second specified event, iteratively receiving an additional shareable quote from the provider trading system via the second shareable quote stream, converting the additional shareable quote into an additional customer-specific quote comprising a size part equal to the minimum of the different tier limit, the available order size and the requested order size, and sending the additional customer-specific quote to the customer trading system. These steps effectively link the customer to a different tier for the currency pair.

The requested order size, which is supplied by the customer in the RFQ, typically allows the customer to specify the largest intended order size, which may be very different from the tier limit for the shareable quote stream to which the customer is linked. For example, although a customer my be attached to a shareable quote stream having a tier limit of $50 million dollars, that customer may have no intention of executing any deals having order sizes greater than $25 million. Under these circumstances, the customer may not care to see price quotes for order sizes greater than $25 million. Accordingly, the customer can limit the number of price quotes and order sizes shown to him (and possibly achieve more favorable pricing) by requesting price quotes for the smaller order size of $25 million.

Similarly, although the customer may be linked to a EUR.USD shareable quote stream having a tier limit (tier size) of $50 million, and may be in the market to execute deals having an order size of up to $25 million, the provider may have no current intention of allowing that customer to execute deals larger than $10 million—perhaps because the customer's available credit limit is only $10 million. Accordingly, by specifying “an available order size” for the customer (typically via a quote control gesture), the provider can further restrict the size of the order the customer can execute at the quoted price.

The invention automatically determines a customer-specific size part for each quote sent to the customer by comparing the tier limit for the tier (i.e., the tier ceiling), the customer-specified requested order size and the provider-specified available order size, and using whichever one of these values is currently the smallest.

While a price quote stream is active, a number of different events may arise which could require changing the customer-specific quote stream. For example, the provider may decide to terminate the shareable quote stream because it no longer has access to the particular assets in question. The provider may also decide to move a customer to a different tier or to revise the customer's available credit limit. A customer may log off the system or simply withdraw the RFQ. Thus, in preferred embodiments, the invention may be configured to stop receiving and converting shareable price quotes whenever one of these specified events is detected. The specified event may also be initiated by the quote distributor, which may be configured, for example, to send the provider trading system a request to terminate the shareable quote stream for a currency pair when that shareable quote stream is no longer required by any customers.

If the specified event is the receipt of a revised available order size, then the invention may be configured to convert any additional shareable quotes received via the shareable quote stream into additional customer-specific quotes using the revised available order size (instead of the original available order size), and sending the additional customer-specific quotes to the customer trading system. These steps will typically be repeated until an occurrence of another specified event, such as receiving an RFQ or shareable quote stream termination request.

The arrival of a quote withdrawal gesture from the provider trading system is another significant event that may occur while a quote stream is active. In preferred embodiments, the receipt of such a quote withdrawal message causes the invention to send to the customer trading system a quote withdrawn notice for the most recent customer-specific quote. If an offer to deal for the customer-specific quote is received from the customer trading system after the quote withdrawal message has been received from the provider trading system, then the invention denies the offer to deal.

A gesture is any message, command, instruction or signal transmitted from one online trading computer system to another online trading computer system, or transmitted from one trading processor or component in a computer trading system to another trading processor or component, which message, command, instruction or signal is designed to cause any of these specified events or otherwise control the quoting process. In preferred embodiments of the invention, however, a quote control gesture is one of a defined set (or “catalog”) of fundamental asset trading messages that support multiple higher-level trading protocols (i.e., “workflows”) that characterize most asset trading transactions, but which operate independently from such protocols. Protocol independent gestures are claimed and described in more detail in co-pending application Ser. No. 10/996,603, entitled “Protocol-Independent Asset Trading Gestures,” which was filed on Nov. 26, 2004, and is hereby incorporated herein in its entirety by this reference. In the present invention, the provider responds to the customer's RFQ by sending a quote control gesture, which effectively “links” the customer to the appropriate price quote stream (price tier), depending on the requested currency pair, the requested order size, the order size that the provider is willing to allow the customer to execute, and the prices the provider wishes to make available to the customer.

Unlike conventional stream-enabled quoting systems, the present invention may be configured to associate each one of one or more incoming shareable quote streams with a multiplicity of outgoing customer-specific quote streams. Therefore, when RFQs have been received from multiple customers for a currency pair and the customer-specific quote streams have been started, there will typically exist a one-to-many relationship between shareable quote streams supplied by the provider trading system and the customer-specific quote streams transmitted to the customer trading systems where the RFQs originated.

In another aspect of the invention, there is provided an online trading system, comprising a customer communication interface, a provider communication interface and a quote distributor. The customer communication interface, which is typically coupled to a customer trading system via the Internet or a wide area network (WAN), receives from the customer trading system an RFQ comprising a currency pair and a requested order size. The provider communication interface, which is coupled to the customer communication interface, transmits the RFQ to a provider trading system and receives from the provider trading system responses to the RFQ. The quote distributor, which is coupled to both the customer communication interface and the provider communication interface, establishes a shareable quote stream for the provider trading system for the currency pair, the shareable quote stream having a tier limit, and receives from the provider trading system, via the provider communication interface, a quote control gesture comprising an available order size (e.g., a credit limit) for the customer trading system. Until one of the aforementioned specified events occurs, the quote distributor iteratively (i) receives a shareable quote from the provider trading system via the shareable quote stream, (ii) converts the shareable quote into a customer-specific quote comprising a size part equal to the minimum of the tier limit, the available order size and the requested order size, and (iii) sends the customer-specific quote to the customer trading system via the customer communication interface.

The quote distributor and communications interfaces may be implemented, for example, in one or more computer software programs configured to execute on one or more microprocessors residing on the online trading server. In addition, the communications interfaces typically include one or more network adaptor cards, coupled to wired or wireless data communications links, which are configured to carry data to and from provider trading systems via a packet-switched data communications network. The network adapter cards are typically controlled by software-based network device drivers.

In preferred embodiments, the quote distributor comprises or is coupled to a shareable quote stream database or table, which stores information about the shareable quote stream, such as the provider's name, an identifier for the shareable quote stream, and the tier limit for the shareable quote stream. When the invention receives a quote control gesture from a provider trading system indicating that a certain customer should be linked to an identified shareable quote stream, then a record is entered into the shareable quote stream data table to identify the provider, the customer, the provider-specified available order size for the customer, and the customer-specified requested order size. As there may be many customers linked to any particular shareable quote stream, and many providers supplying a multiplicity of quote streams (a few quote streams of various tiers for many currency pairs), the shareable quote stream data table provides the quote distributor with the information it needs to quickly determine how an incoming shareable quote should be converted into a customer-specific quote and where that customer specific quote should be sent.

The online trading system may include a multiplicity of customer communication interfaces (one for each customer), which are all configured to receive RFQs sent by those customers, the RFQs comprising the currency pair and a requested order size. These RFQs are passed to one or more providers via one or more provider communication interfaces. The quote distributor is configured to attach multiple customer trading systems to a single shareable quote stream. For example, if the quote distributor receives a first quote control gesture from a provider indicating that customer A should be attached to the provider's $50 million EUR.USD shareable quote stream, and then receives a second quote control gesture from the same provider indicating that customer B should also be attached to the same shareable quote stream (albeit perhaps with a higher or lower available order size), then the quote distributor will attach both customer A and customer B to the same shareable quote stream and iteratively generate and send each customer customized quotes until the occurrence of a specified event, such as the provider's termination of that shareable quote stream.

### BRIEF DESCRIPTION OF THE DRAWINGS

The present invention and various aspects, features and advantages thereof are explained in detail below with reference to exemplary and therefore non-limiting embodiments and with the aid of the drawings, which constitute a part of this specification and include depictions of the exemplary embodiments. In these drawings:

FIG. 1 contains a high-level block diagram illustrating the major functional components of an online trading system configured to operate according to an embodiment of the invention.

FIGS. 2 and 3 contain a high-level flow diagram illustrating the steps that might be performed in an online trading server configured to operate according to an embodiment of the invention, such as, for example, the online trading system depicted in FIG. 1.

FIGS. 4A, 4B, 4C, 5A, 5B, 5C, 6A, 6B, 6C, 7A, 7B and 7C contain block diagrams further illustrating by example the sequence of steps that may be performed by a quote distributor configured to operate according to the present invention.

FIG. 8 contains a Unified Modeling Language (UML) sequence diagram illustrating a preferred protocol for establishing and controlling shareable quote streams according to embodiments of the invention.

FIG. 9 contains a UML sequence diagram showing a preferred protocol for managing individual customer interactions according to embodiments of the invention.

### DETAILED DESCRIPTION OF PREFERRED EMBODIMENTS

With reference to the figures, a detailed discussion of exemplary embodiments of the invention will now be presented. Notably, the invention may be implemented using software, hardware, firmware, or any combination thereof, as would be apparent to those of skill in the art upon reading this disclosure.

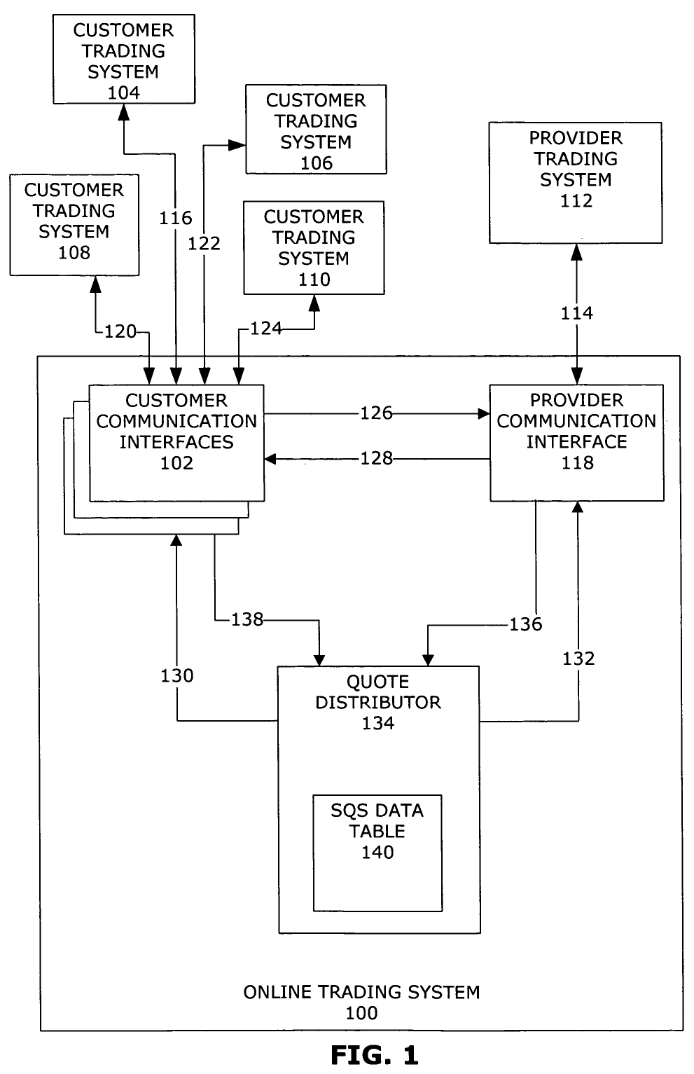

FIG. 1 contains a high-level block diagram illustrating the major functional components of an online trading system configured to operate according to an embodiment of the invention. As shown in FIG. 1, online trading system 100 comprises one or more customer communication interfaces 102, provider communication interface 118 and quote distributor 134, which are all coupled to each other through various data communications links 126, 128, 130, 132, 136 and 138. Customer communication interfaces 102 are configured to send messages to and receive messages from a plurality of customer trading systems (shown in FIG. 1 as customer trading systems 104, 106, 108 and 110) via data communications links 120, 116, 122 and 124. Preferably, but not necessarily, these messages are exchanged in the form of protocol-independent gestures, as claimed and described in co-pending application Ser. No. 10/996,603.

Provider communication interface 118 communicates messages (preferably, in the form of protocol-independent trading gestures) with provider trading system 112. For purposes of clarity and ease of understanding in the discussion that follows, FIG. 1 shows only one provider communication interface and one provider trading system. It should be understood, however, that preferred embodiments of the invention typically include multiple provider communication interfaces, which communicate with multiple provider trading systems. As illustrated by the simplified drawing in FIG. 1, preferred embodiments of the invention are designed to take advantage of the fact that there are typically many customer-side data communication links (e.g., data communications links 120, 116, 122 and 124) for every one provider-side data communication link (e.g., data communication link 114). Thus, any information (such as shareable quotes) delivered to the online trading server via the single data communication link 114 may be converted and then simultaneously transmitted in parallel to many different customer trading systems.

When a customer wishes to see a stream of quotes for a currency pair, customer trading system (e.g., customer trading system 108) sends an RFQ for a stream of quotes to online trading system 100 via data communications link 120. The RFQ is received by the appropriate customer communication interface 102 and is typically passed directly to provider communication interface 118 via data communications link 126. Provider communication interface 118 passes that RFQ to provider trading system 112 and receives the provider's response via data communications link 114. One possible response is that the provider will decide to provide a stream of quotes to customer trading system 108, but not a shareable stream. In other words, the provider can decide, for any number of reasons, to establish a private, dedicated and end-to-end communications link (not shown in FIG. 1) with customer trading system 108. Another possibility is that the provider will simply refuse to provide quotes to customer trading system 108. In either case, the refusal is typically passed directly to the customer trading system by way of data communication link 128 and the appropriate customer communication interface 102. When the provider refuses to provide shareable quote streams to the customer, then there is typically no further action to be performed by the invention, unless, of course, the invention is also configured to handle dedicated, end-to-end streaming functions and/or execute logging and documentation functions associated with the refusal.

On the other hand, the provider could also decide to service the RFQ by linking the customer to an established shareable quote stream for the requested currency pair and order size, or, if no shareable quote stream for the requested currency pair and order size currently exists, by establishing a new shareable quote stream and then attaching the customer to the newly established stream. If quote distributor 134 receives an RFQ from customer interfaces 102 and no appropriately sized shareable quote stream for the requested currency pair exists, then quote distributor 134 sends to the appropriate provider trading system an invitation to create an appropriately-sized shareable quote stream. The provider trading system 112 responds by sending a shareable quote stream creation gesture to quote distributor 134 via data communications link 114, provider communication interface 118 and data communications link 136.

If an appropriate quote stream already exists, then quote distributor 134 sends the RFQ to provider trading system 112. Preferably, provider trading system 112 is configured to respond to the RFQ by sending to quote distributor 134 a quote control gesture, which tells quote distributor 134 to attach the customer to the existing shareable quote stream. The quote control gesture also specifies the maximum available order size for the customer, which me derived as a function of the customer's current credit limit, the provider's ability to acquire or sell the assets in question, the provider's overall market position with respect to the assets in question, etc. Receipt of a quote control gesture or shareable quote stream creation gesture causes quote distributor 134 to create new entries in SQS data table 140, which stores information concerning providers, shareable quote streams, and customers, so that quote distributor may later access this information for purposes of quickly determining what to do with incoming shareable quotes.

Once a shareable quote stream is established, the stream of shareable quotes may also be transmitted to quote distributor 134 via data communications link 114, provider communication interface 118 and data communications link 136. Alternatively, another data communications link (not shown in FIG. 1) may be dedicated to receiving all quote streams from provider trading system 112. In either case, quote distributor 134 uses information stored in shareable quote stream data table 140 to convert each shareable quote into a customer specific quote and to send the customer specific quote to the appropriate customer trading system 104, 106, 108, 110, or all of the them, via data communications link 130 and customer communication interfaces 102. As stated above, one difference between the incoming shareable quotes and the outgoing customer-specific quotes is that the outgoing customer-specific quotes have a size part that is equal to the minimum of the tier limit, the available order size and the requested order size.

Quote distributor 134 will continue to generate and send customer-specific quotes for every shareable quote it receives until an event occurs that requires a change to the outgoing, customer-specific quote stream. Such events include receiving from provider trading system 112 another quote control gesture, a quote withdrawal gesture or a shareable quote stream termination gesture, or receiving from one of the customer trading systems 104, 106, 108 or 110 a logoff request or a gesture to terminate the RFQ.

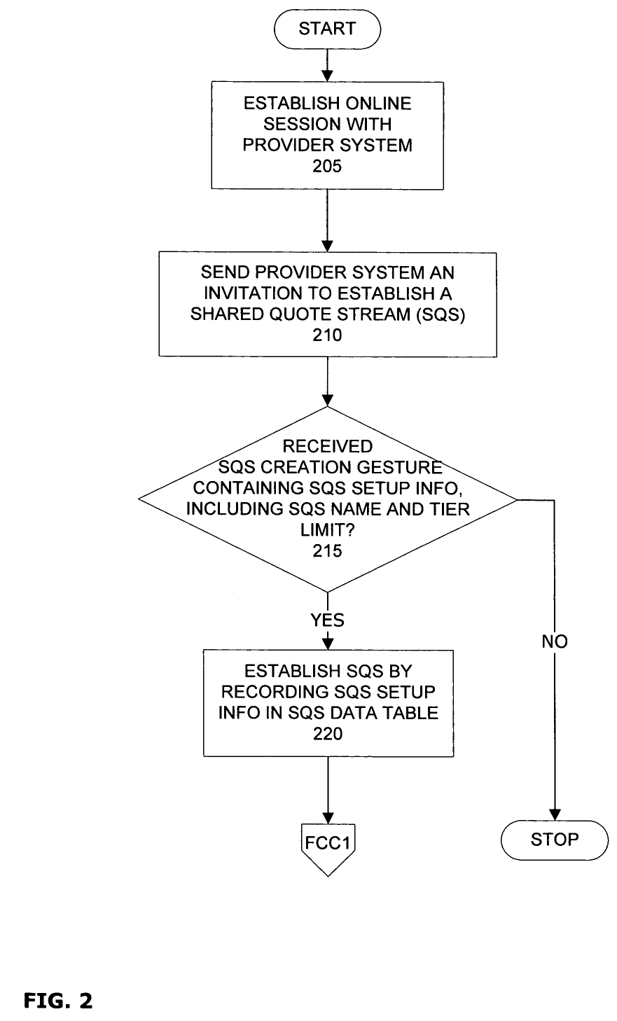

FIG. 2 contains a high-level flow diagram illustrating the steps that might be performed by an online trading system configured to operate according to embodiments of the invention, such as online trading system 100 depicted in FIG. 1, to establish shareable quote streams. In the first step, step 205, the online trading system establishes an online session with the provider system. This step includes, for example, responding to a login request received from the provider system and validating passwords. In preferred embodiments, the online trading system next sends the provider system an invitation to establish one or more shared quote streams for a multiplicity of popular currency pairs (step 210), such as, for example, EUR.USD, USD.GBP, USD.JPY, etc. The invitation may be sent even though no customer has yet expressed any interest in seeing quotes for these particular currency pairs by submitting RFQs. Alternatively, the system may be configured to invite the provider to establish new shareable quote streams only after receiving an RFQ from a customer.

Next, at step 215, the system determines whether it has received a shareable quote stream creation gesture from the provider system. If it is determined at step 215 that the provider system has not sent a shareable quote stream creation gesture, then shareable quote stream processing for that provider is stopped, no shareable quote stream is created for that provider, and any RFQs sent to that provider will have to be serviced without using shareable quote streams or otherwise refused. On the other hand, if the provider does send a shareable quote stream creation gesture, then the gesture preferably includes information required to establish the shareable quote stream, such as the provider's name, the shareable quote stream name and the tier limit for this particular shareable quote stream. All of this information is then recorded in the shareable quote stream data table (step 220).

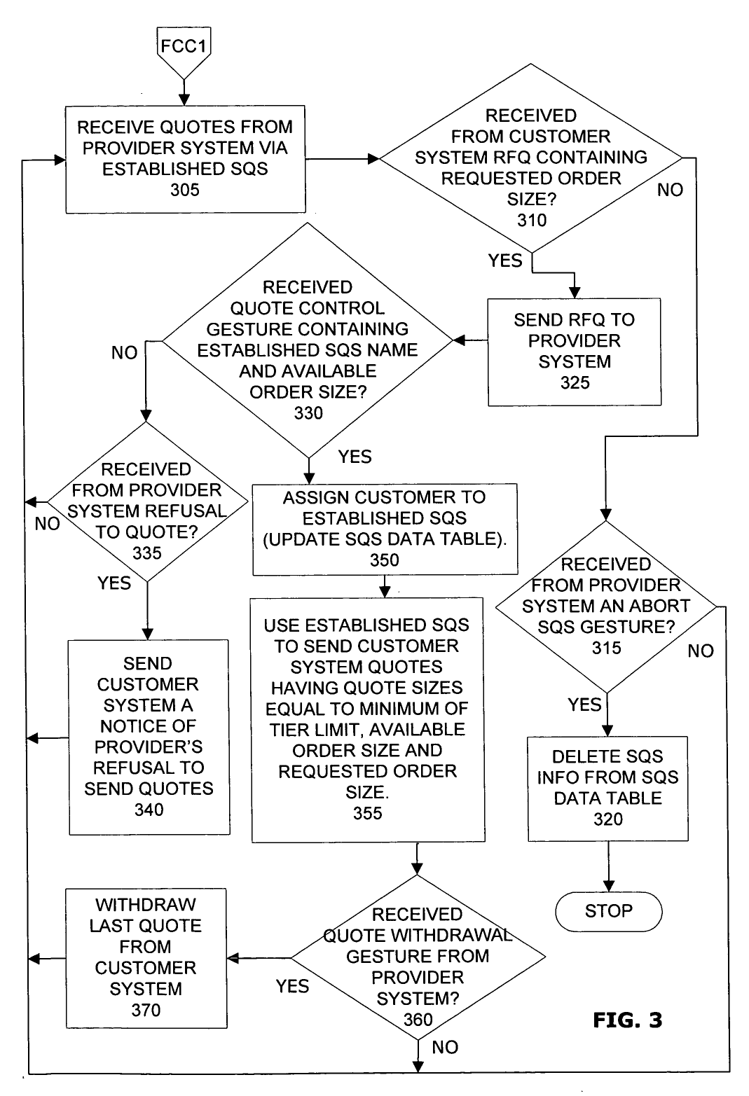

At this point, shareable quote streams have been established and the system can start receiving quotes. Accordingly, processing continues at step 305 in FIG. 3 by way of flow chart connector 1 (FCC1), wherein the system starts receiving quotes from the provider system via the established shareable quote stream. Shareable quotes do not contain the order size part because the order size part will need to customized for each customer, and may even need to be customized for every successive quote.

Next, at step 310, the system checks to see if it has received from a customer system any RFQs. When a customer sends an RFQ, the customer provides a proposed set of terms, including a requested order size for the customer, which typically indicates to the provider the maximum size the customer intends to order. Deals done on the basis of the stream may have any size up to and including the customer's requested order size.

If no RFQ was received, then the system determines, at step 315, whether the provider has sent an abort shareable quote stream gesture to terminate the quote stream. If the answer is yes, then the system deletes the shareable quote stream info from the shareable quote stream data table (step 320) and processing stops. However, if the answer is no, then processing returns to step 305, wherein the system receives additional shareable quotes from the provider system via the established shareable quote stream.

If it is determined at step 310 that the system has received an RFQ from a customer system for a supported currency pair, then the RFQ is sent to the provider system (step 325). At step 330, the system determines whether the provider system has responded to the RFQ by sending a quote control gesture containing the name of an established shareable quote stream to use and an available order size. If the answer is yes, then the system assigns the customer to the named established shareable quote stream (step 350) by updating the shareable quote stream data table with the customer's name and available order size.

Next, at step 355, the system generates and delivers quotes having size parts that are no greater than the customer's requested size, the tier limit, or the provider-specified available order size for the customer, whichever is lowest. Accordingly, if the provider sends a shareable quote with an available order size that is larger than the customer's requested order size, then the online trading system of the present invention is configured to create a customer-specific quote having a size part that is reduced to match the requested order size. On the other hand, if the customer supplies a requested order size that is larger than the provider-specified available order size (which is typically limited by the customer's credit limit or some other factor, such as the provider's limited access to the assets), then the system is configured to create a customer-specific quote that has a size part that has been reduced to match the available order size.

The system is also configured to reduce the size part of customer-specific quotes so that they are never larger than the tier limit for the shareable quote stream. Therefore, if a provider has requested that a particular customer be attached to a shareable quote stream having a tier limit of $10 million, then the system of the present invention will never send that customer customer-specific quotes having a size part larger than $10 million, no matter what the customer's requested order size or the provider's available order size happen to be.

After a customer-specific quote has been sent to a customer, the customer may be allowed to submit offers to deal against any one or more of the customized quotes. The offers to deal may be handled in any number of ways. Preferably, however, the offers to deal are handled according to systems and methods claimed and described in co-pending application Ser. No. ______, entitled Dynamic Liquidity Management System,” which is filed on even-date herewith.

The system also may receive a quote withdrawal gesture from the provider system. The system checks for this condition at step 360. If the quote withdrawal gesture was received, then the system withdraws the quote (step 370) by sending a quote withdrawn notice to the customer and, from that point on, rejecting any offers to deal received for the withdrawn quote.

If it is determined at step 330 that the provider did not respond to the RFQ by submitting a quote control gesture, then the system checks to see if the provider sent a refusal to quote (step 335). If not, then processing returns again to step 305, where the system waits for more shareable quotes to arrive. On the other hand, if a refusal to quote has been received, then the system sends notice of the refusal to the customer system (step 340) before returning again to step 305 to await more shareable quotes. If the system has received no control gesture and no refusal to quote, then either the customer system or the online server, or both, may optionally be configured to time out and send one or both parties a notice. These optional operations are not shown in FIG. 3.

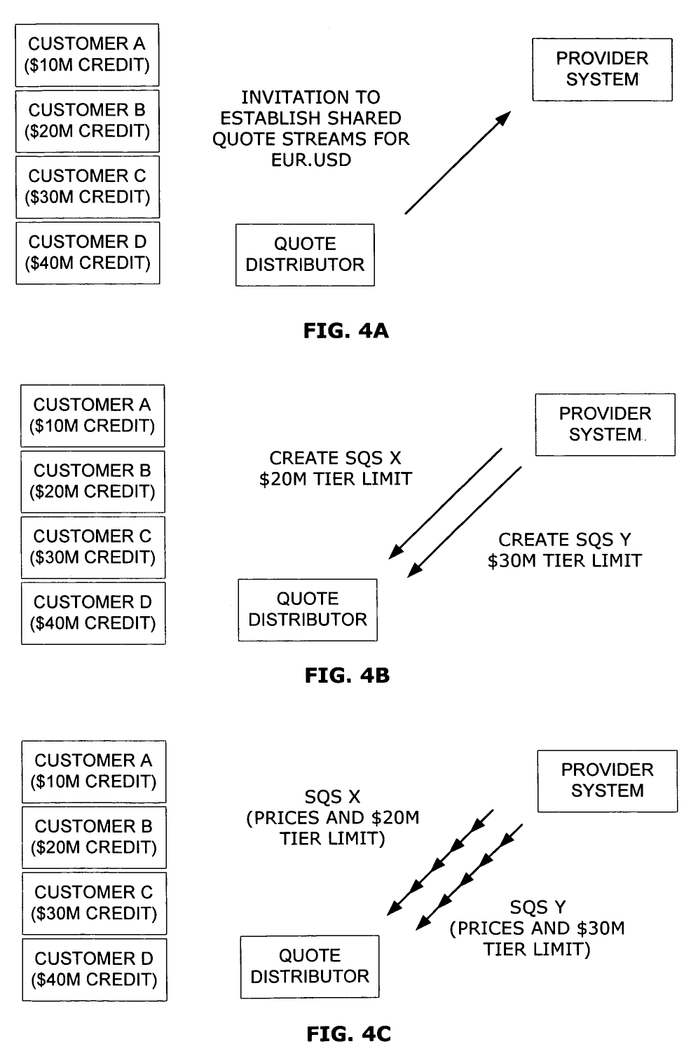

FIGS. 4A-4C, 5A-5C, 6A-6C and 7A-7C illustrate, by way of example, some of the steps performed by online trading systems (or, more specifically, a quote distributor) configured to operate according the principles of the present invention. As shown in all of these figures, customer A has a credit limit of $10 million, customer B has a credit limit of $20 million, customer C has a credit limit of $30 million and customer D has a credit limit of $40 million.

In FIG. 4A, the quote distributor sends an invitation (which may constitute a specially-tagged RFQ, for example) to the provider to establish a shared quote stream for the currency pair EUR.USD. In FIG. 4B, the provider responds by sending two quote stream creation gestures to create two different shareable quote streams, SQS X and SQS Y. SQS X has a tier limit of $20 million and SQS Y has a tier limit of $30 million. In preferred embodiments of the invention, shared quote streams may be created at any time before they are used by a provider to respond to an RFQ. In FIG. 4C, the provider starts streaming quotes for SQS X and SQS Y to the quote distributor. Quotes can be freely sent and withdrawn, or a shareable quote stream may be terminated by the provider, at any time.

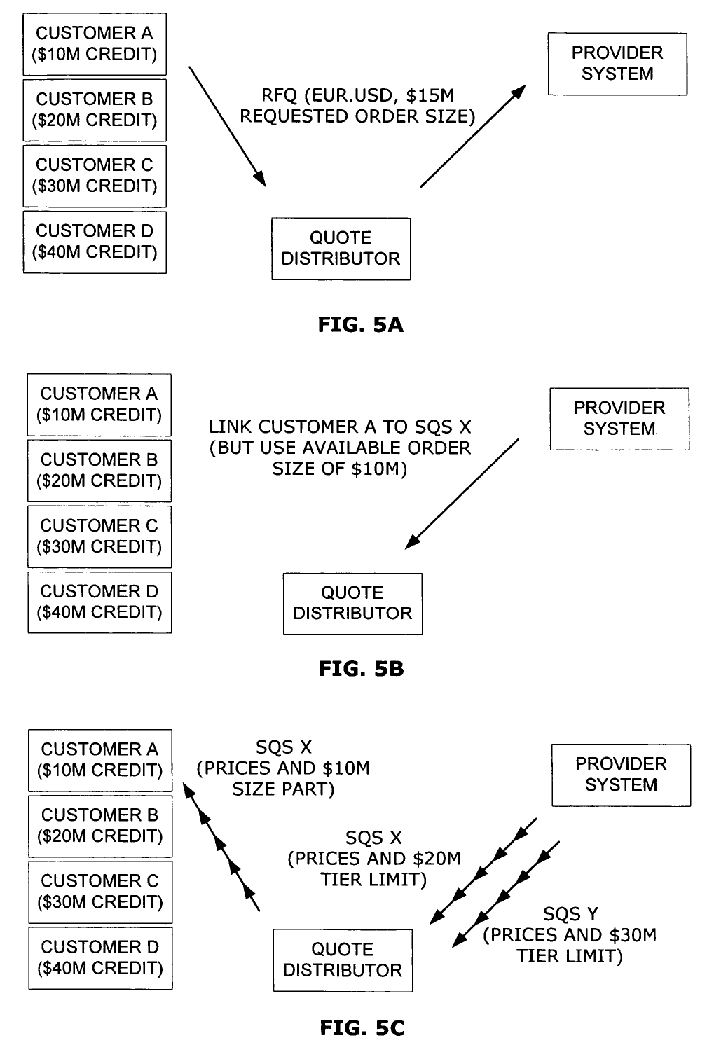

In FIG. 5A, customer A sends an RFQ to the quote distributor requesting quotes for EUR.USD in order sizes of up to $15 million. In FIG. 5B, the provider accepts the RFQ, sending a quote control gesture indicating that customer A should be linked to SQS X and that customer A's available order size is $10 million (to match customer A's credit limit). In FIG. 5C, the quote distributor distributes SQS X prices to customer A, but customer A sees quotes having a size part of $10 million, which is the minimum of: the tier limit for SQS X; the provider-specified available order size for customer A; and customer A's requested order size.

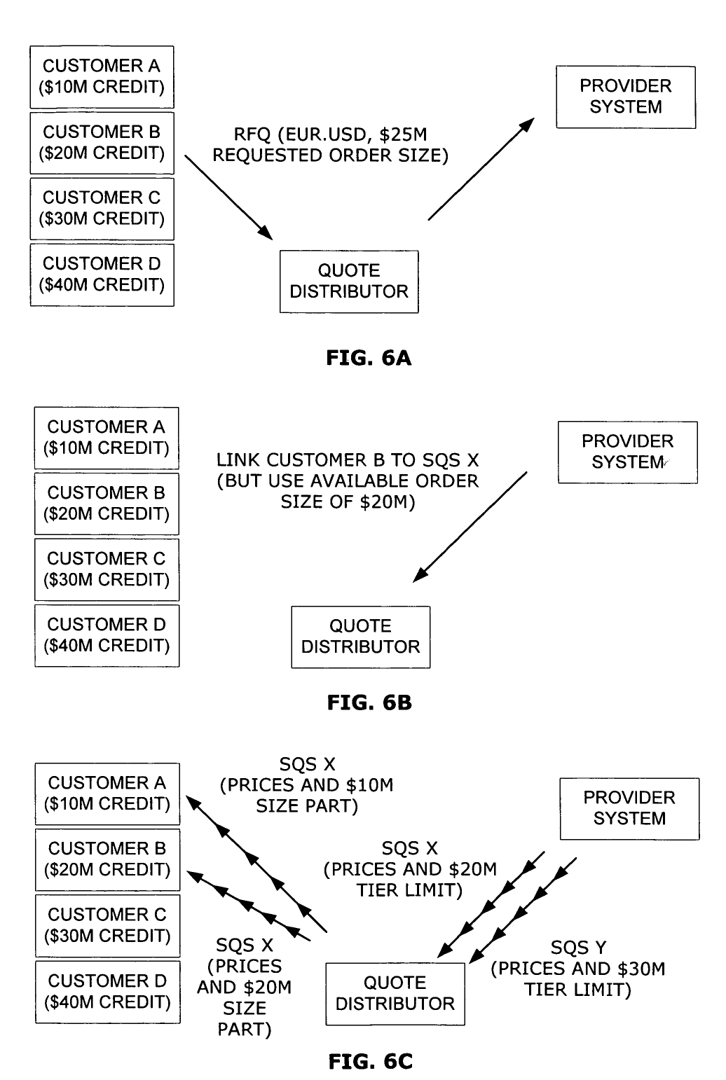

In FIG. 6A, customer B sends an RFQ to the quote distributor requesting quotes for EUR.USD in order sizes of up to $25 million. In FIG. 6B, the provider accepts the RFQ, sending a quote control gesture indicating that customer B should be linked to SQS X and that customer B's available order size is $20 million (to match customer B's credit limit, as sell as the tier limit of SQS X). In FIG. 6C, the quote distributor distributes SQS X prices to customer B, but customer B sees quotes having a size part of $20 million, which is the minimum of: the tier limit for SQS X; the provider-specified available order size for customer B; and customer B's requested order size. Meanwhile, customer A is still receiving quotes on SQS X that have a size part of $10 million.

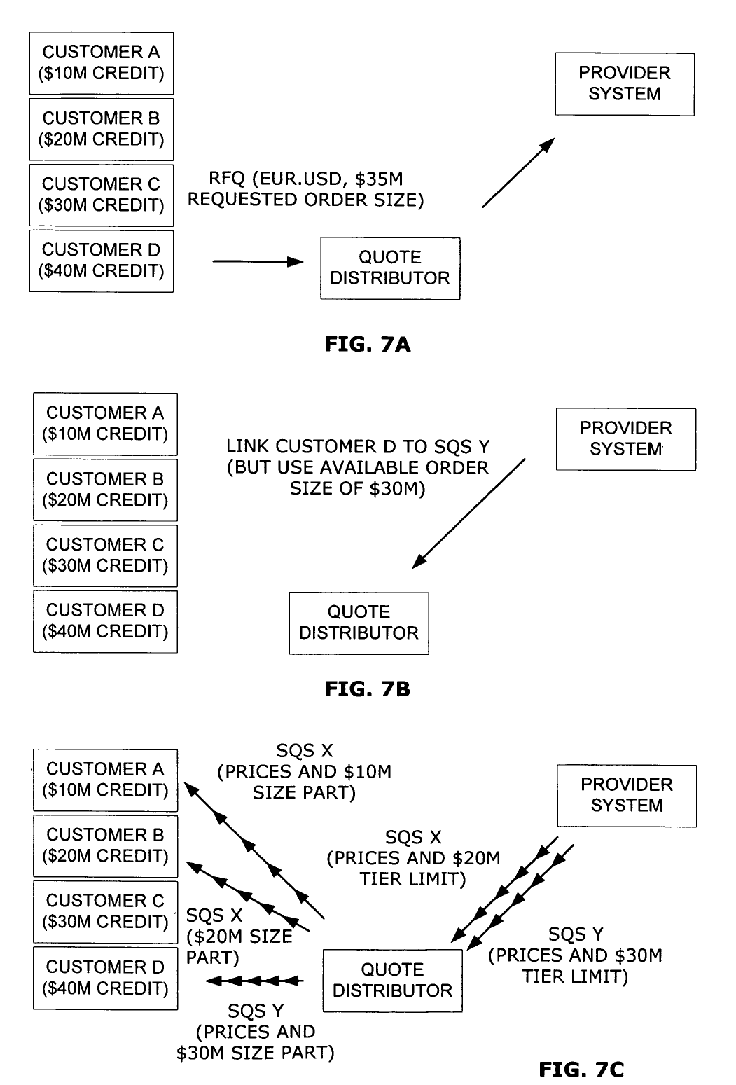

In FIG. 7A, customer D sends an RFQ to the quote distributor requesting quotes for EUR.USD in order sizes of up to $35 million. In FIG. 7B, the provider accepts the RFQ, sending a quote control gesture indicating that customer D should be linked to SQS Y and that customer D's available order size is $40 million (to match customer D's credit limit). In FIG. 7C, the quote distributor distributes SQS X prices to customer D, but customer D sees quotes having a quote size part of $30 million, which is the minimum of: the tier limit for SQS Y; the provider-specified available order size for customer D; and customer D's requested order size. Meanwhile, customer A is still receiving quotes on SQS X that have a size part of $10 million, and customer B is still receiving quotes on SQS X that have a size part of $20 million.

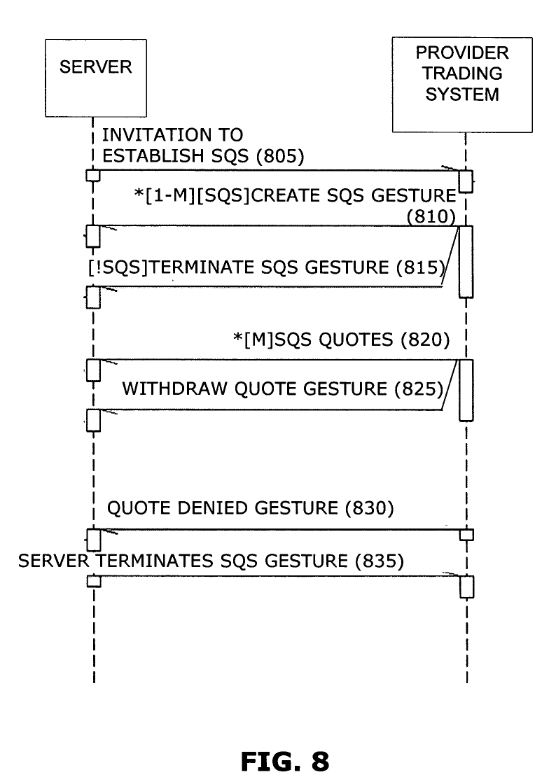

The UML sequence diagram of FIG. 8 shows a preferred protocol for establishing and controlling shareable quote streams. As shown in FIG. 8, the preferred protocol begins when the server sends the provider trading system an invitation to establish a shareable quote stream (805). In preferred embodiments, the server sends one invitation for each currency pair supported by the server, for each currency pair supported by the provider, or for each currency pair supported by both the provider and the server. The provider responds to each currency pair invitation by sending a create SQS gesture (message 810) from one to as many times as it likes (the one-to-many option is represented in FIG. 8 by the “[1−M][SQS]” guard on message No. 810). Each create SQS gesture creates a new shareable quote stream (tier) for the currency pair, each one having a specified tier limit. Alternatively, if the provider does not wish to create any shareable quote streams for the currency pair, the provider may respond to the invitation by sending a terminate SQS gesture (815), which creates no shareable quote streams for the currency pair. Next (at 820), the provider trading system iteratively sends shareable quotes to the server. Each quote is associated with one shareable stream (tier). A withdraw quote gesture (825) applies to the last quote on one shareable quote stream. The provider may also send a “quote denied” message after any number of shareable streams have been created and quotes have been sent. If the provider sends a quote denied message (830), then preferred embodiments of the invention are configured to destroy all shareable streams for this currency pair. Finally, the server may also terminate a shareable stream (835) in cases where, for example, quotes for a particular currency pair are no longer requested by any customer.

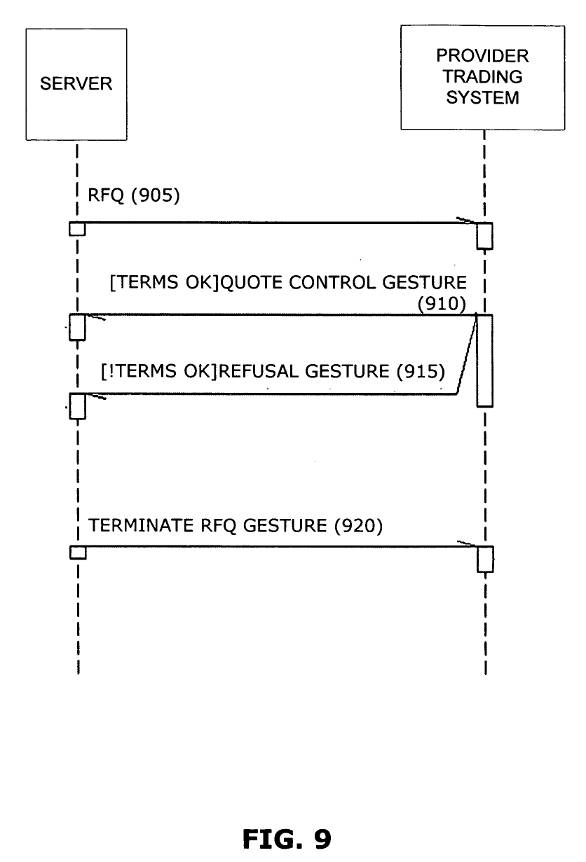

Once one or more shareable quote streams are established, customers may be associated with them and receive shareable quotes. FIG. 9 contains a UML sequence diagram showing a preferred protocol for managing individual customer interactions, according to embodiments of the invention, once the quoting begins. As shown in FIG. 9, the protocol begins with an RFQ (905). The RFQ includes the customer's requested order size. The provider reviews the RFQ, and, if the terms are okay, then the provider sends a quote control gesture (910) that includes an identifier for the shareable quote stream and an available order size for the customer. On the other hand, if the terms of the RFQ are not okay, then the provider may send a refusal to provide quotes (915). A refusal may be sent after any number of quote control gestures. Finally, if all customers are finished with a shareable stream, preferred embodiments of the invention are configured to send the provider a terminate RFQ gesture. This gesture is a courtesy notification for the provider.

The present invention has been disclosed and described herein in what is considered to be its most preferred embodiments. It should be noted that variations and equivalents may occur to those skilled in the art upon reading the present disclosure and that such variations and equivalents are intended to come within the scope of the invention and the appended claims. It should also be noted that, while the preferred embodiments of the invention are described in the context of foreign exchange (FX) transactions, the principles of the invention may be beneficially applied to other types of transactions as well. Therefore, it should be understood by one skilled in the art for example, that the present invention is not limited to the embodiments described above or to foreign exchange transactions alone.

What is claimed is:

1. A method of providing quotes in an online asset trading network, comprising:
(a) establishing with a provider trading system a first shareable quote stream for a currency pair, said first shareable quote stream having a tier limit;
(b) receiving from a customer trading system a request for quotes comprising a requested order size;
(c) transmitting said request for quotes to said provider trading system;
(d) receiving from said provider trading system a quote control gesture comprising an available order size for said customer trading system;
(e) receiving a shareable quote from said provider trading system via said first shareable quote stream;
(f) converting said shareable quote into a customer-specific quote comprising a size part equal to the minimum of said tier limit, said available order size and said requested order size;
(g) sending said customer-specific quote to said customer trading system; and
(h) iteratively repeating steps (e)-(g) until an occurrence of a specified event.

2. The method of claim 1, wherein said specified event comprises receiving from said provider trading system a request to terminate said first shareable quote stream.

3. The method of claim 1, wherein said specified event comprises receiving from said customer trading system a request to terminate said request for quotes.

4. The method of claim 1, wherein said specified event comprises sending to said provider trading system a request to terminate said first shareable quote stream.

5. The method of claim 1, wherein said specified event comprises receiving from said provider trading system a second quote control gesture comprising a revised available order size for said customer trading system.

6. The method of claim 5, further comprising, after said occurrence of said specified event:
(i) receiving an additional shareable quote from said provider trading system via said first shareable quote stream;
(j) converting said additional shareable quote into an additional customer-specific quote comprising a new size part equal to the minimum of said tier limit, said revised available order size and said requested order size;
(k) sending said additional customer-specific quote to said customer trading system; and
(l) iteratively repeating steps (i)-(k) until an occurrence of a second specified event.

7. The method of claim 6, wherein said second specified event comprises receiving from said provider trading system a request to terminate said first shareable quote stream.

8. The method of claim 6, wherein said second specified event comprises receiving from said customer trading system a request to terminate said request for quotes.

9. The method of claim 6, wherein said second specified event comprises sending to said provider trading system a request to terminate said first shareable quote stream.

10. The method of claim 1, further comprising establishing with said provider trading system a second shareable quote stream for said currency pair, said second shareable quote stream having a different tier limit.

11. The method of claim 10, wherein said specified event comprises receiving from said provider trading system a second quote control gesture comprising an identifier for said second shareable quote stream.

12. The method of claim 11, further comprising:
(m) receiving an additional shareable quote from said provider trading system via said second shareable quote stream;
(n) converting said additional shareable quote into an additional customer-specific quote comprising a size part equal to the minimum of said different tier limit, said available order size and said requested order size;
(o) sending said additional customer-specific quote to said customer trading system; and
(p) iteratively repeating steps (m)-(o) until an occurrence of a second specified event.

13. The method of claim 12, wherein said second specified event comprises receiving from said provider trading system a request to terminate said second shareable quote stream.

14. The method of claim 12, wherein said second specified event comprises receiving from said customer trading system a request to terminate said request for quotes.

15. The method of claim 12, wherein said second specified event comprises sending to said provider trading system a request to terminate said second shareable stream.

16. The method of claim 12, wherein said second specified event comprises receiving from said provider trading system a third quote control gesture comprising a revised available order size for said customer trading system.

17. The method of claim 1, wherein said quote control gesture further comprises an identifier for said first shareable stream of quotes.

18. The method of claim 1, wherein said available quote size is based on a credit limit.

19. The method of claim 1, further comprising sending to said provider trading system an invitation to establish said first shareable quote stream.

20. The method of claim 1, further comprising:
receiving from said provider trading system a quote withdrawal gesture;
sending to said customer trading system a quote withdrawn notice for said customer-specific quote; and
if an offer to deal for said customer-specific quote is received, denying said offer to deal.

21. The method of claim 1, further comprising:
(i) receiving from a second customer trading system a second request for quotes comprising a second requested order size;
(j) transmitting said second request for quotes to said provider trading system;
(k) receiving from said provider trading system a second quote control gesture comprising a second available order size for said second customer trading system;
(l) converting said shareable quote into a second customer-specific quote comprising a second size part equal to the minimum of said tier limit, said second available order size and said second requested order size;
(m) sending said second customer-specific quote to said second customer trading system; and
(n) iteratively repeating steps (k)-(m) until an occurrence of a second specified event.

22. The method of claim 21, wherein said second specified event comprises receiving from said provider trading system a request to terminate said first shareable quote stream.

23. The method of claim 21, wherein said second specified event comprises receiving from said second customer trading system a request to terminate said second request for quotes.

24. The method of claim 21, wherein said second specified event comprises sending to said provider trading system a request to terminate said first shareable quote stream.

25. The method of claim 21, wherein said second specified event comprises receiving from said provider trading system a third quote control gesture comprising a revised available order size for said second customer trading system.

26. An online trading system, comprising:
a customer communication interface that receives from a customer trading system a request for quotes comprising a currency pair and a requested order size;
a provider communication interface, coupled to said customer communication interface, that transmits said request for quotes to a provider trading system; and
a quote distributor that establishes a shareable quote stream for said provider trading system for said currency pair, said shareable quote stream having a tier limit, and that receives from said provider trading system, via said provider communication interface, a quote control gesture comprising an available order size for said customer trading system;
wherein, until an occurrence of a specified event, said quote distributor iteratively (i) receives a shareable quote from said provider trading system via said shareable quote stream, (ii) converts said shareable quote into a customer-specific quote comprising a size part equal to the minimum of said tier limit, said available order size and said requested order size, and (iii) sends said customer-specific quote to said customer trading system via said customer communication interface.

27. The online trading system of claim 26, wherein said specified event comprises said quote distributor receiving from said provider trading system a request to terminate said shareable quote stream.

28. The online trading system of claim 26, wherein said specified event comprises said quote distributor receiving from said customer trading system a request to terminate said request for quotes.

29. The online trading system of claim 26, wherein said specified event comprises said quote distributor sending to said provider trading system a request to terminate said shareable quote stream.

30. The online trading system of claim 26, wherein said specified event comprises said quote distributor receiving from said provider trading system a second quote control gesture comprising a revised available order size for said customer trading system.

31. The online trading system of claim 30, wherein, after said occurrence of said specified event and until an occurrence of a second specified event, said quote distributor iteratively
(i) receives an additional shareable quote from said provider trading system via said shareable quote stream;
(ii) converts said additional shareable quote into an additional customer-specific quote comprising a new size part equal to the minimum of said tier limit, said revised available order size and said requested order size; and
(iii) sends said additional customer-specific quote to said customer trading system via said customer communication interface.

32. The online trading system of claim 26, wherein said quote distributor establishes a second shareable quote stream with said provider trading system for said currency pair, said second shareable quote stream having a different tier limit.

33. The online trading system of claim 32, further comprising:
a second customer communication interface that receives from a second customer trading system a second request for quotes comprising said currency pair and a second requested order size;
wherein said quote distributor receives from said provider trading system, via said provider communication interface, a second quote control gesture comprising an second available order size for said second customer trading system; and
until an occurrence of a second specified event, said quote distributor iteratively (i) receives a second shareable quote from said provider trading system via said second shareable quote stream, (ii) converts said second shareable quote into a second customer-specific quote comprising a second quote size equal to the minimum of said different tier limit, said second available order size and said second requested order size, and (iii) sends said second customer-specific quote to said second customer trading system via said second customer communication interface.

34. The online trading system of claim 33, wherein said second specified event comprises said quote distributor receiving from said provider trading system a request to terminate said second shareable quote stream.

35. The online trading system of claim 33, wherein said second specified event comprises said quote distributor receiving from said second customer trading system a request to terminate said second request for quotes.

36. The online trading system of claim 33, wherein said second specified event comprises said quote distributor sending to said provider trading system a request to terminate said second shareable quote stream.

37. The online trading system of claim 33, wherein said second specified event comprises said quote distributor receiving from said provider trading system a second quote control gesture comprising a second revised available order size for said second customer trading system.

38. The online trading system of claim 26, further comprising a shareable quote stream data table, coupled to said quote distributor, configured to store an identifier for said shareable quote stream, said tier limit, said available order size and said requested order size.

39. An online trading system, comprising:
(a) means for establishing with a provider trading system a first shareable quote stream for a currency pair and a tier limit;
(b) means for receiving from a customer trading system a request for quotes comprising a requested order size;
(c) means for transmitting said request for quotes to said provider trading system;
(d) means, responsive to said transmitting means, for receiving from said provider trading system a quote control gesture comprising an available order size for said customer trading system;
(e) means for receiving a shareable quote from said provider trading system via said first shareable quote stream;
(f) means for converting said shareable quote into a customer-specific quote comprising a size part equal to the minimum of said tier limit, said available order size and said requested order size;
(g) means for sending said customer-specific quote to said customer trading system; and
(h) means for iteratively repeating steps (e)-(g) until an occurrence of a specified event.

40. The online trading system of claim 39, wherein said specified event comprises receiving from said provider trading system a request to terminate said first shareable quote stream.

41. The online trading system of claim 39, wherein said specified event comprises receiving from said customer trading system a request to terminate said request for quotes.

42. The online trading system of claim 39, wherein said specified event comprises sending to said provider trading system a request to terminate said first shareable quote stream.

43. The online trading system of claim 39, wherein said specified event comprises receiving from said provider trading system a second quote control gesture comprising a revised available order size for said customer trading system.

44. The online trading system of claim 43, further comprising:
(i) means for receiving an additional shareable quote from said provider trading system via said first shareable quote stream;
(j) means for converting said additional shareable quote into an additional customer-specific quote comprising a new size part equal to the minimum of said tier limit, said revised available order size and said requested order size;
(k) means for sending said additional customer-specific quote to said customer trading system; and
(l) means for iteratively repeating steps (i)-(k) until an occurrence of a second specified event.
